(19) United States
(12) Patent Application Publication
(10) Pub. No.: US 2026/0154189 A1
(43) Pub. Date: Jun. 4, 2026

(54) ARTIFICIAL INTELLIGENCE (AI) BASED STAGING VALIDATION SYSTEM FOR TELECOMMUNICATIONS NETWORK PRODUCTS

(71) Applicant: T-Mobile USA, Inc., Bellevue, WA (US)

(72) Inventors: Henry P. Cyril, Bothell, WA (US); Shrustishree Sumanth, Bellevue, WA (US)

(21) Appl. No.: 18/968,923

(22) Filed: Dec. 4, 2024

(51) Int. Cl. G06F 11/3698; G06F 8/65

(52) U.S. Cl. CPC G06F 11/3698; G06F 8/65

(57) ABSTRACT

A system receives staging test results associated with a software product from a staging testing unit. The staging test results are obtained by testing the software product with a test set that imitates a real production environment. The test set includes associations of a set of customer-facing service (CFS) features and a set of network-facing service (NFS) features, and the staging test results include identified anomalies arising from the associations of the set of CFS features and the set of NFS features. The system processes, using an artificial intelligence model, the staging test results to produce a confidence value indicating whether the identified anomalies have a likelihood of causing a failure of the software product when deployed in the real production environment, and determines, using the confidence value, whether to deploy the software product in the real production environment.

### BACKGROUND

Staging in the context of software products refers to the process of preparing, testing, and validating software updates or new software products in a controlled, pre-production environment before deploying them to the live environment to ensure compatibility and performance. Staging aims to ensure that a software product is compatible with existing network infrastructure, performs as expected, and does not introduce any unforeseen issues that could compromise network stability or performance. An efficient and reliable staging process is essential to minimize risks and ensure a seamless transition from development to deployment of software products.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a system for management of network services.

FIG. 4 is a block diagram that illustrates a staging system for software products related to network services.

FIG. 5 is a block diagram that illustrates a staging validation system for a staging system.

FIG. 6 is a flow diagram that illustrates a process for validating telecommunications network software products for production deployment.

FIG. 7 is a block diagram that illustrates an example of a computer system in which at least some operations described herein can be implemented.

FIG. 8 is a block diagram that illustrates an example of an artificial intelligence (AI) system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Deploying network products involves provisioning such products by a network provisioning engine (NPE). Provisioning requires translating customer-facing services (CFSs) from the billing system into network-facing services (NFSs). Anomalies between the CFSs and NFSs can lead to the failure of products when deployed in a real production environment. Conventionally, staging can be used to test and validate software products in a controlled, pre-production environment that attempts to imitate a real production environment to ensure compatibility and performance. However, conventionally staging can be performed only on limited testing sets of CFSs and NFSs, and involves time-consuming manual validation of staging test results. Such limited testing sets can lead to a significant amount of failures for deployed products arising from additional, non-tested CFSs and NFSs associations and/or other non-tested deployment environment factors. Further, the conventionally used test sets are pre-determined, and updating the test sets dynamically is not practical.

The present technology provides for a proactive outage prediction system for telecommunications networks. Specifically, the present technology is configured to predict network outages for new network products or upgrades to existing network products that arise from anomalies in provisioning such products. The system integrates an artificial intelligence (AI) based staging validation utility to a staging system. The staging validation utility can dynamically add test cases from production, validate system resources, perform dynamic validation based on network element load and response times, conduct stress testing, and compare a variety of configurations. In contrast to reacting to anomalies post-occurrence, the present technology allows a proactive approach that enhances the reliability and smoothness of the provisioning process. Also, other current architecture limitations, such as the inability to validate all attributes and the lack of dynamic and comprehensive testing, are addressed by the present technology to improve the validation process and overall network performance. Overall, the present technology can provide a more accurate, dynamic prediction of whether network software products are likely to fail when deployed and therefore reduce product failures when implementing new products. Also, the technology can enable proactive prediction of failures that take into consideration a larger scenario of implementations compared to those available in a limited staging test environment.

In one example, an AI-based staging validation system for validating telecommunications network software products for production deployment comprises at least one hardware processor and at least one non-transitory memory storing instructions. When executed by the at least one hardware processor, these instructions cause the system to receive staging test results associated with a software product from a staging testing unit. The staging test results are obtained by testing the software product with a test set that imitates a real production environment. The test set includes associations of a first set of customer-facing service (CFS) features and a first set of network-facing service (NFS) features, and the staging test results include identified anomalies arising from the associations of the first set of CFS features and the first set of NFS features. The system processes, using an AI model, the staging test results to produce a first confidence value indicating whether the identified anomalies have a likelihood of causing a failure of the software product when deployed in the real production environment. Additionally, the system dynamically receives additional test cases extracted from one or more deployed software products. The additional test cases are selected to include at least one association between CFS features and NFS features different from the associations in the test set, and deployed software products are deployed in the real production environment. The system processes, using the AI model, the additional test cases to produce a second confidence value predicting whether the additional test cases would cause a failure of the software product when deployed in the real production environment. The system determines, using the first confidence value and the second confidence value, whether to deploy the software product in the real production environment.

In another example, a staging validation system for validating software products for production deployment comprises at least one hardware processor and at least one non-transitory memory storing instructions. When executed by the at least one hardware processor, these instructions cause the system to receive staging test results associated with a software product from a staging testing unit. The staging test results are obtained by testing the software product with a test set that imitates a real production environment. The test set includes associations of a set of customer-facing service (CFS) features and a set of network-facing service (NFS) features, and the staging test results include identified anomalies arising from the associations of the set of CFS features and the set of NFS features. The system processes, using an AI model, the staging test results to produce a confidence value indicating whether the identified anomalies have a likelihood of causing a failure of the software product when deployed in the real production environment, and determines, using the confidence value, whether to deploy the software product in the real production environment.

In yet another example, a computer-implemented method for validating telecommunications network software products for production deployment comprises receiving staging test results associated with a software product. The staging test results include associations of a first set of customer-facing service (CFS) features and a first set of network-facing service (NFS) features, and the staging test results include identified anomalies arising from the associations of the first set of CFS features and the first set of NFS features. The method further includes processing, using an AI model, the staging test results to produce a first confidence value indicating whether the identified anomalies have a likelihood of causing a failure of the software product when deployed in a real production environment. Additionally, the method involves receiving additional test cases extracted from one or more deployed software products. The additional test cases are selected to include at least one association between CFS features and NFS features different from the associations in the test set. The method also includes processing, using the AI model, the additional test cases to produce a second confidence value predicting whether the additional test cases would cause a failure of the software product when deployed in the real production environment. Finally, the method determines, using the first confidence value and the second confidence value, whether to deploy the software product in the real production environment.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

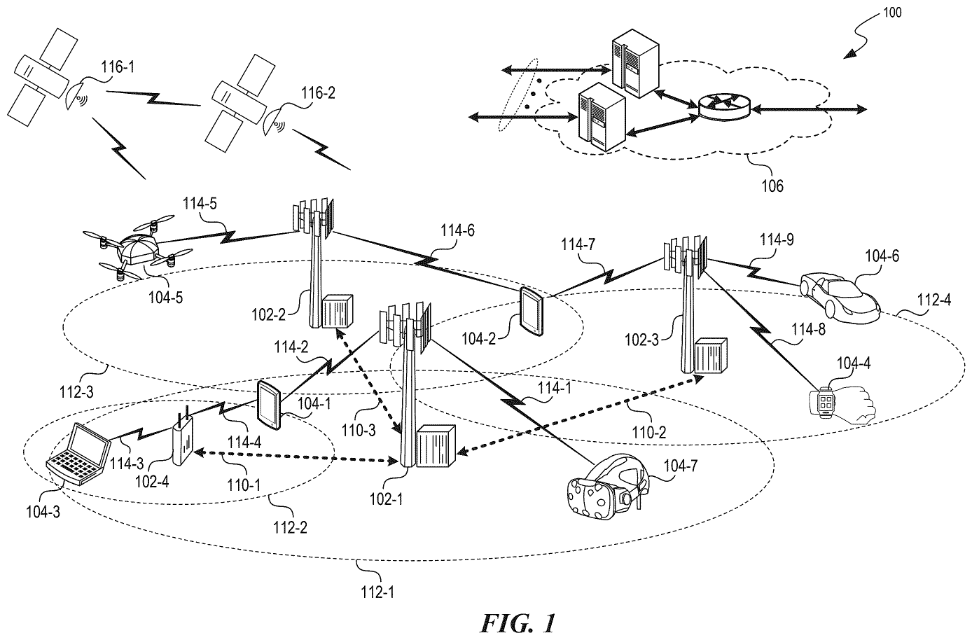

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### 5G Core Network Functions

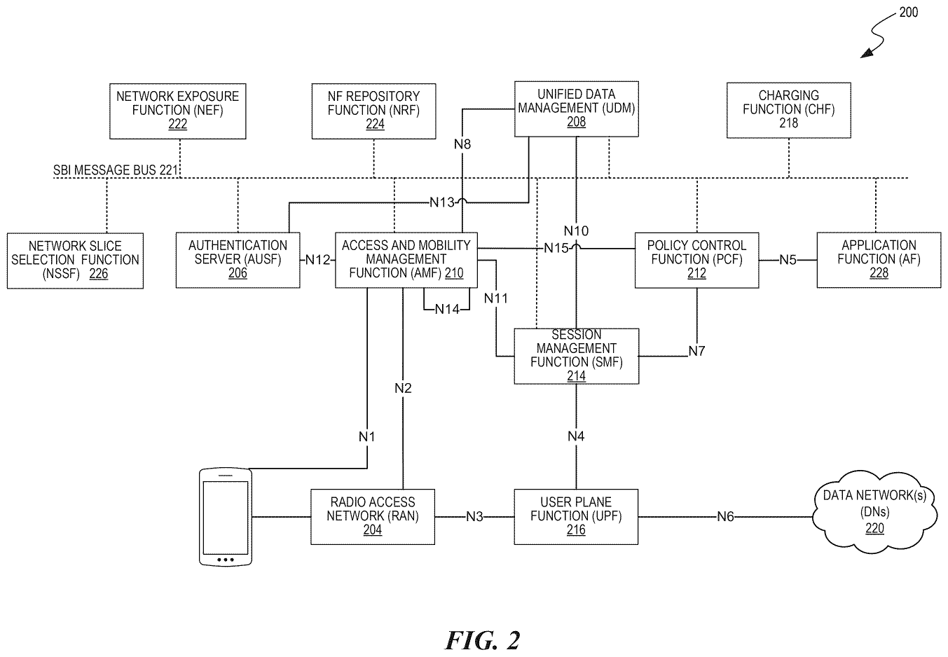

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Staging Validation

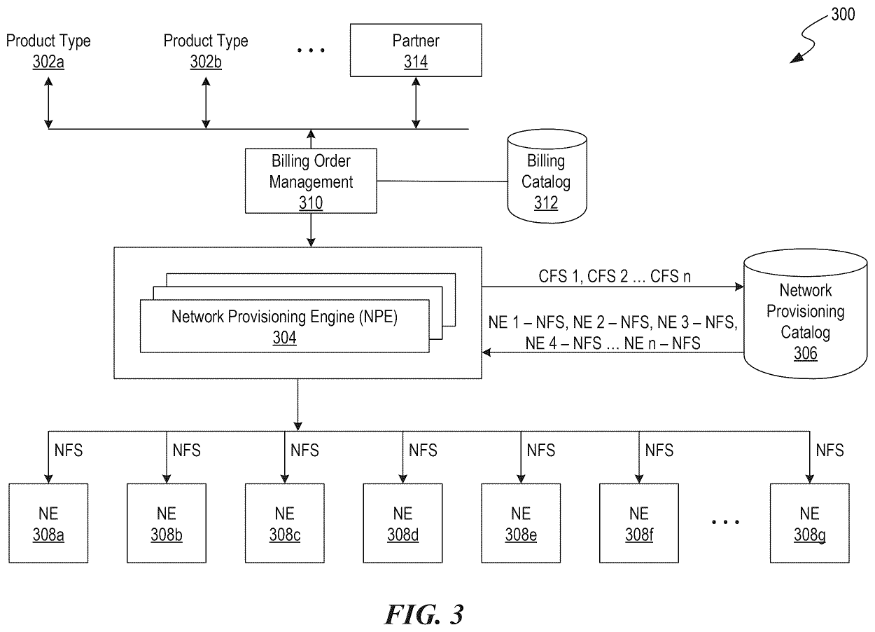

FIG. 3 is a block diagram that illustrates a system 300 for management of network services. The system 300 includes a network provisioning engine (NPE) 304, a billing order management 310, a billing catalog 312, a network provisioning catalog 306, and multiple network elements (NEs) 308 (e.g., NEs 308 including NEs 308a through 308g).

The NPE 304 is configured to manage network services enabling operation of wireless devices in a network (e.g., the wireless devices 104 in the wireless network 100 in FIG. 1). The network services are provided to wireless devices via the NEs 308 such as base stations (e.g., the base stations 102 in FIG. 1). In some implementations, the NEs can include routers, switches, gateways, firewalls, and other equipment that facilitate wireless communication and data transfer. A new network service product (or a modification to an existing network service product) can be requested by the billing order management 310 (e.g., through an Application Programming Interface (API)) as an activation provision request. For example, the billing order management 310 sends a request for a new product to the NPE 304. The new product is defined by CFSs (e.g., CFS 1, CFS 2, . . . )(also referred to as CFS features). The CFSs define a variety of functionalities and can be specific to product types (e.g., product types 302a and 302b) and partners (e.g., a partner 314). A product type can refer to, for example, a pre-paid versus postpaid network service. A partner can include a third-party service provider that collaborates with the network service provider associated with the wireless network (e.g., the wireless network 100 of FIG. 1). A first product type requires a first set of CFSs, a second product type requires a second set of CFSs, and a partner requires a third set of CFSs where the first, second, and third sets of CFSs can be different from each other. Exemplary services that can be defined by CFSs include rate plans; add-on services; which access point name to use; whether the partner or product type uses the network service provider's voicemail service; whether short message service (SMS) is enabled; limitations on data usage; whether roaming is enabled; whether 5G standalone is enabled; whether real-time data metering is enabled; and whether Internet of Things (IoT) is enabled.

The sets of CFSs associated with the product types or partners are defined by and retrieved from the billing catalog 312 by the billing order management 310. The sets of CFSs are received from the billing order management 310 by the NPE 304, which transmits the CFSs to the network provisioning catalog 306. The network provisioning catalog 306 is a repository that contains configurations, resources, and information required to provision network services to customers. The network provisioning catalog 306 translates the received sets of CFSs to sets of NFSs associated with the NEs 308. For example, a set of CFSs required for a new network product is translated by the network provisioning catalog 306 so that the network infrastructure (e.g., including the NEs 308) can be provisioned to provide the new network product to clients. The NPE 304 can receive the NFSs from the network provisioning catalog 306 and facilitate implementation of the product through the NEs 308. Anomalies in the network provisioning, for example, disparities between the CFSs and the NFSs for a product, can cause a failure of the product.

As an example, when a customer purchases a new service associated with a product type (e.g., the product type 302a or 302b), the transaction is processed by the NPE 304 as an activation provision request, which includes a list of CFSs. The CFSs can define, for example, services such as voice call, SMS, data, Wi-Fi calling, scam protection, and companion device pairing. The network provisioning catalog 306 translates these CFSs into NFSs. The NFSs can include thousands of network attributes that are associated with the CFSs (e.g., around 10,000 network attributes). The NPE 304 provisions various NEs (e.g., 10 to 20 NEs) through multiple APIs to enable the new service. However, the service may fail due to network element outages or downtime, misconfigured or down NPE clusters, lack of backup clusters to route traffic, NPE clusters reaching their threshold or limit, performance issues causing transaction failures, geographical failures leading to system desynchronization between redundant locations, or API microservices downtime due to memory leaks or out-of-memory errors. Predicting whether a failure would occur can therefore require a complex analysis. Stage testing and validation is required to identify any anomalies in the provisioning of the new product.

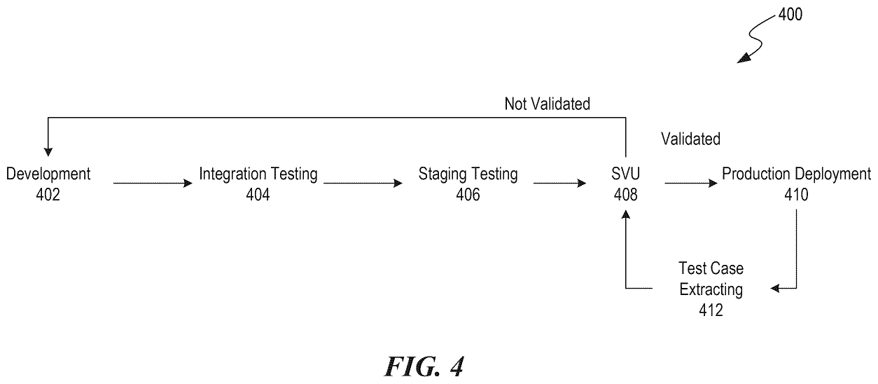

FIG. 4 is a block diagram that illustrates a staging process 400 with a staging validation utility (SVU) 408 for software products related to network services. The staging process 400 includes operation of development 402, integration testing 404, staging testing 406, SVU 408, production deployment 410, and a new test case extracting 412. The development 402 of software products (e.g., software applications) related to network services includes designing and coding of new software products or modifications to existing software products. After development 402, a new software product undergoes the operation of integration testing 404. The integration testing 404 of new software products can include combining individual software modules and testing them as a group to identify any issues in their interactions and data flow. The integration testing 404 can aim to ensure, for example, that the integrated components of the new software product work together correctly and meet the specified requirements. The integration testing 404 can enable detection of interface defects and anomalies. After the integration testing 404, the new product undergoes the operation of staging testing 406. The staging testing 406 can include evaluating a software application in an environment that closely imitates the real production environment. The evaluation can include testing with application data as well as environment data. The environment can include mimicking hardware aspects in order to provide a more accurate representation of a system load and performance. The staging testing 406 aims to identify products that are predicted to function without failures in a real production environment before deployment of a product. In the staging testing 406, the new product is tested in a limited testing environment that includes, for example, just a portion of all CFS and NFS associations (combinations) that can possibly be present in the real production environment.

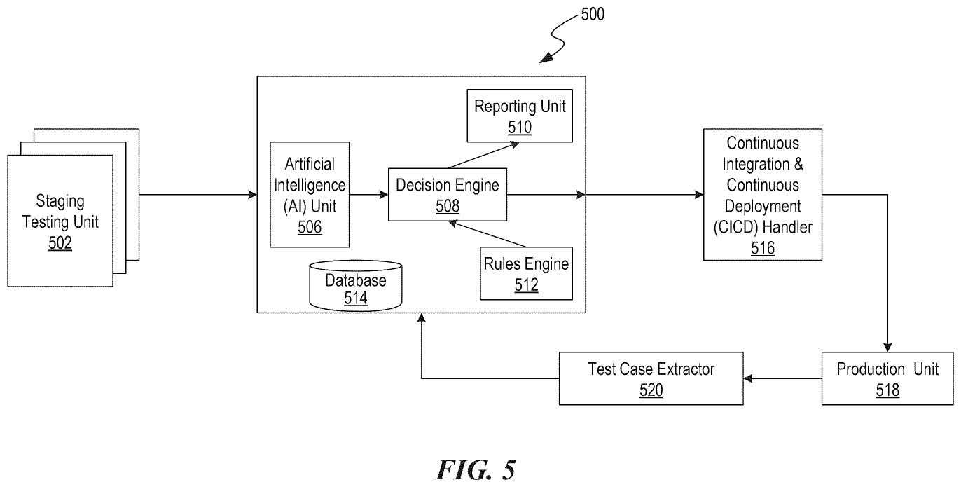

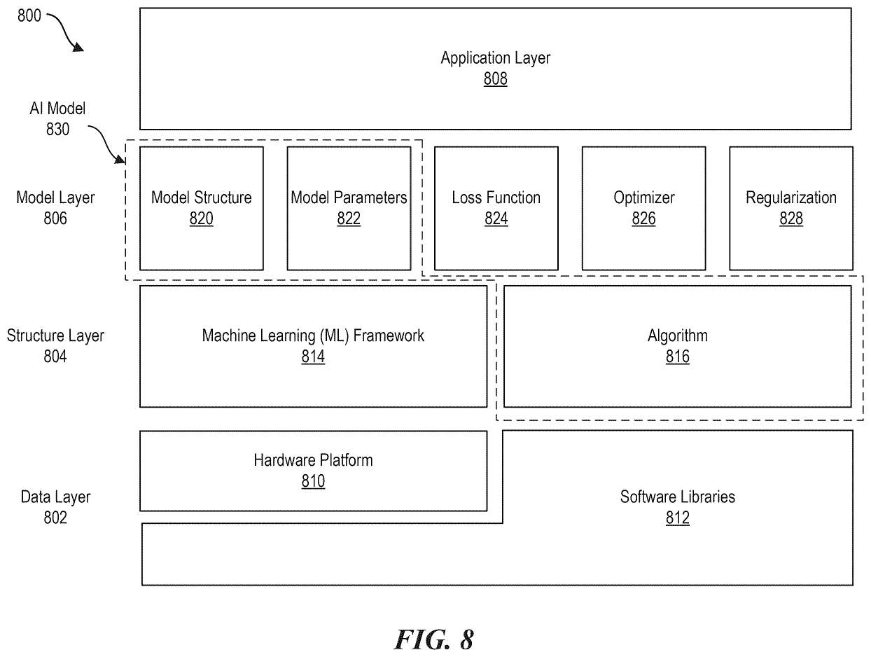

The test results from the staging testing 406 are transmitted to the SVU 408. The SVU 408 is an AI-based operation used to verify whether a new software product will function without failures in a real production environment. In addition to the test results from the staging testing 406, the SVU 408 receives additional test cases extracted (e.g., by the operation of test case extracting 412) from production deployment 410 (e.g., corresponding to a real-world deployment environment). A system for performing the operation of SVU 408 is described in detail with respect to FIG. 5. Principles of AI algorithms are described in detail with respect to FIG. 8. Products that are validated by the SVU 408 are transmitted to production deployment 410 while products that are not validated by the SVU 408 are returned to the operation of development 402 for further development.

The AI-based SVU 408 can provide a more accurate prediction of whether a new software product would fail in a real production environment than a prediction that is made solely based on the staging testing. For example, while the staging testing 406 is performed in a limited test environment, the SVU 408 can extend the evaluation to a significantly larger environment (e.g., by the additional test cases extracted from the production deployment 410). Further, the AI-based SVU 408 can detect, by a trained AI algorithm, anomalies not detectable by the staging testing 406. Such anomaly detection and validation can include, for example, operation of system resources (processing, memory, disk storage), dynamic validation for amount of traffic or data processing demand placed on NEs, response times of NEs, stress testing with transaction rate (e.g., transactions per second (TPS)), and/or network configuration evaluation.

FIG. 5 is a block diagram that illustrates a staging validation system 500 for a staging system (e.g., the staging process 400 in FIG. 4). The system 500 is configured to perform the operation of SVU 408 described with respect to FIG. 4. The system 500 includes an AI unit 506, a decision engine 508, a reporting unit 510, a rules engine 512, and a database 514.

The system 500 receives staging test results from a staging testing unit 502 and test cases from a test case extractor 520. The test cases can be extracted from a production environment (e.g., a production unit 518). The staging testing unit 502 can be configured to perform the operation of staging testing 406 as described with respect to FIG. 4. The staging test results and extracted test cases can be processed by the AI unit 506. The AI unit 506 can include an algorithm (e.g., a machine learning algorithm) trained to identify anomalies and to predict whether a software product would fail in a real production environment. The anomalies can include, for example, disparities between the CFSs and the NFSs defined for the product (e.g., as described with respect to FIG. 3). The AI unit 506 can input the staging test results and the extracted text cases to the trained algorithm and receive a prediction (e.g., a predicted confidence value) indicating whether the software product is likely to operate correctly (without failures) when deployed in a real production environment. In some instances, the AI algorithm provides a first confidence value using the staging test results and a second confidence value using the extracted test cases. In some instances, the AI algorithm provides a combined confidence value.

The predictions (confidence values) produced by the AI unit 506 are transmitted to the decision engine 508 configured to validate whether a product should be deployed into production. The decision engine 508 can receive relevant rules from the rules engine 512 and compare the predictions received from the AI unit 506 against the relevant rules. The rules can determine, for example, a threshold confidence value that must be reached in order for a product to be deployed. The threshold confidence value can vary based on a product type (e.g., the product types 302a and 302b in FIG. 3) or a partner (e.g., the partner 314). The rules can also vary based on a type of anomaly detected. For example, a first type of anomaly can be associated with a first threshold confidence value and a second type of anomaly can be associated with a second threshold confidence value that is different from the first threshold confidence value.

The decision engine 508 can report the validation results for a new product by transmitting the validation result to the reporting unit 510. The decision can further be stored in the database 514 (or a data storage). In an instance wherein a new product has been validated by the decision engine 508 (e.g., the decision engine 508 determines that the new product should be deployed in production), the decision engine 508 transmits an indication to a continuous integration and continuous deployment (CICD) handler 516. The CICD handler 516 can deploy the software product in the real production environment (e.g., the production unit 518). In an instance wherein the decision engine 508 does not validate the results (e.g., the decision engine 508 determines that the new product should not be deployed in production), the system 500 can return the product for further development (as described with respect to FIG. 4).

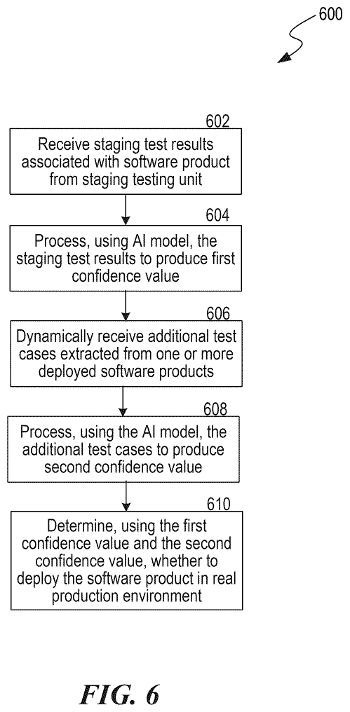

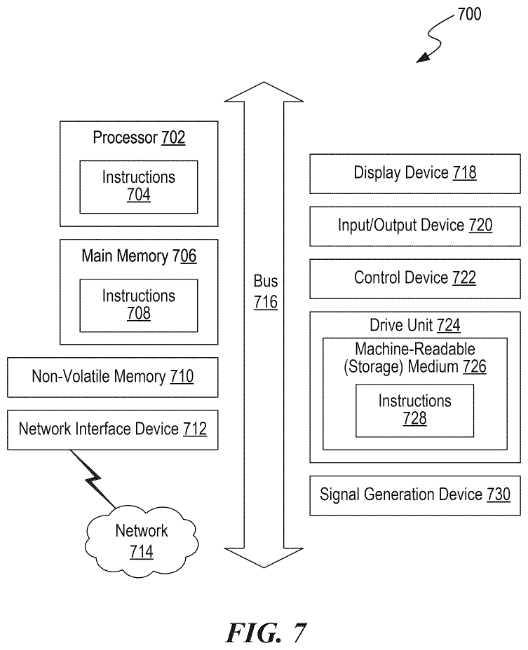

FIG. 6 is a flow diagram that illustrates a process 600 for validating telecommunications network software products for production deployment. The validating process 600 can be performed by a system (e.g., the system 500 in FIG. 5) associated with a wireless network (e.g., the wireless network 100 in FIG. 1). In some implementations, the system is a server system. The system can be associated with a telecommunications network and include at least one hardware processor and at least one non-transitory memory storing instructions (e.g., a computer system 700 described with respect to FIG. 7). When the instructions are executed by the at least one hardware processor, the system performs the process 600. The process 600 is directed toward performing AI-based validation of new or upgraded network software products before deploying such products in a real production environment. The process 600 can provide a more accurate, dynamic prediction of whether network software products are likely to fail when deployed and therefore reduce product failures when implementing new products. Specifically, the process 600 can enable proactive prediction of failures that takes into consideration a larger scenario of implementations compared to those available in a limited staging test environment.

At 602, the system can receive staging test results associated with a software product from a staging testing unit. For example, the stating validation system 500 receives staging test results from the staging test unit 502 in FIG. 5. The staging test results can be obtained by testing the software product with a test set that imitates a real production environment. The test set can include associations of a first set of customer-facing service (CFS) features and a first set of network-facing service (NFS) features. The staging test results can include identified anomalies arising from the associations of the first set of CFS features and the first set of NFS features.

In some implementations, the first set of CFS features is a subset of CFS features (e.g., the CFSs described with respect to FIG. 3) pre-defined by a billing system (e.g., the billing order management 310 in FIG. 3). The first set of CFS features can be associated with a type of software product or a client associated with the software product (e.g., the product types 302a and 302b and the partner 314 in FIG. 3). In some implementations, the first set of NFS features is a subset of NFS features (e.g., the NFSs described with respect to FIG. 3) that a network provisioning engine (NPE) uses to provision multiple network engines to enable the software product for a customer. The NFS features can be defined by a network provisioning catalog (e.g., the network provisioning catalog 306) in communication with the NPE using the CFS features pre-defined by a billing system.

At 604, the system can process, using an AI model, the staging test results to produce a first confidence value indicating whether the identified anomalies have a likelihood of causing a failure of the software product when deployed in the real production environment. The failure can refer to a partial or full failure of the software product in the real production environment (e.g., the production deployment 410 in FIG. 4).

At 606, the system can dynamically receive additional test cases extracted from one or more deployed software products. For example, the staging validation system 500 receives additional test cases from the test case extractor 520 in FIG. 5. The additional test cases are extracted from the production unit 518 which corresponds to the real production environment. The additional test cases can be selected to include associations between CFS features and NFS features different from the associations in the test set. Deployed software products can be deployed in the real production environment. In some implementations, the additional test cases are dynamically (e.g., continuously or sequentially) extracted from the real production environment.

As an example, in a real production environment, there can be around ten thousand CFSs that are then provisioned as translated NFSs with about 15 different network elements for about 20 APIs. For practical reasons, staging test results can include limited results for, for example, up to four thousand test cases. The staging test results represent only a fraction of the cases possible in the real production environment. In contrast, the process 600 can take into consideration, using the trained AI model, any number of real production environment cases. The staging can include both the application data and the hardware to compare the performance statistics. For example, staging can include a subset of the production (e.g., a subset corresponding to 1/24 of total) hardware capacity for sufficiently accurate measure of performance. For example, if the production can support 2400 TPS (transaction per second), the staging will support 100 TPS ( 1/24th of the capacity). The staging can test performance in the subset and extrapolate the anticipated performance in real production environment.

At 608, the system can process, using the AI model (e.g., an AI model operated in the AI unit 506 in FIG. 5), the additional test cases to produce a second confidence value predicting whether the additional test cases would cause a failure of the software product when deployed in the real production environment. In some implementations, processing the additional test cases using the AI model includes identifying anomalies arising from associations of a second set of CFS features and a second set of NFS features. The system can provide a prediction of whether the identified anomalies would cause failure of the software product when deployed in the real production environment. For example, the AI unit 506 can produce the prediction and provide it to the decision engine 508 for further processing, as described with respect to FIG. 5.

At 610, the system (e.g., the decision engine 508 in FIG. 5) can determine, using the first confidence value and the second confidence value, whether to deploy the software product in the real production environment.

In some implementations, responsive to determining to deploy the software product in the real production environment, the system causes deployment of the software product in the real production environment (e.g., in the production unit 518 in FIG. 5). In some implementations, the system is further caused to transmit an indication of the determination of whether the software product should be deployed in the real production environment to a continuous integration and continuous deployment (CICD) handler (e.g., the CICD handler 516). Responsive to a determination that the software product should be deployed, the system can cause the CICD handler to deploy the software product.

In some implementations, determining whether to deploy the software product is performed by a decision engine that receives a set of pre-defined rules from a rules engine. In some implementations, the rules determine a threshold confidence value that must be reached in order for a product to be deployed. The threshold confidence value can be different for different product types (e.g., the product types 302a and 302b in FIG. 3) or a partner (e.g., the partner 314). In some implementations, the rules are different for different types of anomalies detected. For example, a first type of anomaly can be associated with a first threshold confidence value and a second type of anomaly can be associated with a second threshold confidence value that is different from the first threshold confidence value. In some implementations, the identified anomalies are of one or more types of anomalies. A set of pre-defined rules can include different confidence value thresholds for each type of anomaly of the one or more types of anomalies. Determining whether to deploy the software product can include comparing the first confidence value and the second confidence value associated with respective types of anomalies to the set of pre-defined rules for deploying software products.

In some implementations, the AI model is continuously trained using training data extracted from the real production environment. The training data can include types of anomalies arising from associations of CFS features and NFS features and an outcome indicating whether the types of anomalies resulted in a software product failure or not. The continuous training can ensure that the AI model is configured to detect anomalies accurately and with the most up-to-date information associated with the real production environment.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

FIG. 8 is a block diagram that illustrates an example of an AI system 800 in which at least some operations described herein can be implemented. As shown, the AI system 800 can include a set of layers, which conceptually organize elements within an example network topology for the AI system's architecture to implement a particular AI model 830. Generally, an AI model 830 is a computer-executable program implemented by the AI system 800 that analyzes data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form the example AI model 830. The optimizer 826, loss function engine 824, and regularization engine 828 work to refine and optimize the AI model 830, and the data layer 802 provides resources and support for the application of the AI model 830 by the application layer 808.

The data layer 802 acts as the foundation of the AI system 800 by preparing data for the AI model 830. As shown, the data layer 802 can include two sub-layers: a hardware platform 810 and one or more software libraries 812. The hardware platform 810 can be designed to perform operations for the AI model 830 and include computing resources for storage, memory, logic, and networking, such as the resources described in relation to FIG. 5. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 can include Infrastructure as a Service (IaaS) resources, which are computing resources (e.g., servers, memory, etc.), offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of as suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint.

The structure layer 804 can include an ML framework 814 and an algorithm 816. The ML framework 814 can be thought of as an interface, library, or tool that allows users to build and deploy the AI model 830. The ML framework 814 can include an open-source library, an Application Programming Interface (API), a gradient-boosting library, an ensemble method, and/or a deep learning toolkit that work with the layers of the AI system to facilitate the development of the AI model 830. For example, the ML framework 814 can distribute processes for the application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830.

The algorithm 816 can be an organized set of computer-executable operations used to generate output data from a set of input data and can be described using pseudocode. The algorithm 816 can include complex code that allows the computing resources to learn from new input data and create new/modified outputs based on what was learned. In some implementations, the algorithm 816 can build the AI model 830 through being trained while running computing resources of the hardware platform 810. This training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. An artificial intelligence (AI) based staging validation system for validating telecommunications network software products for production deployment, the system comprising:
at least one hardware processor; and
at least one non-transitory memory storing instructions, which, when executed by the at least one hardware processor, cause the system to:
receive staging test results associated with a software product from a staging testing unit,
wherein the staging test results are obtained by testing the software product with a test set that imitates a real production environment,
wherein the test set includes associations of a first set of customer-facing service (CFS) features and a first set of network-facing service (NFS) features, and
wherein the staging test results include identified anomalies arising from the associations of the first set of CFS features and the first set of NFS features;
process, using an AI model, the staging test results to produce a first confidence value indicating whether the identified anomalies have a likelihood of causing a failure of the software product when deployed in the real production environment;
dynamically receive additional test cases extracted from one or more deployed software products,
wherein the additional test cases are selected to include at least one association between CFS features and NFS features different from the associations in the test set, and
wherein deployed software products are deployed in the real production environment;
process, using the AI model, the additional test cases to produce a second confidence value predicting whether the additional test cases would cause a failure of the software product when deployed in the real production environment; and
determine, using the first confidence value and the second confidence value, whether to deploy the software product in the real production environment.

2. The system of claim 1, further caused to:
transmit an indication of the determination of whether the software product should be deployed in the real production environment to a continuous integration and continuous deployment (CICD) handler; and
responsive to a determination that the software product is to be deployed, cause the CICD handler to deploy the software product.

3. The system of claim 1,
wherein the additional test cases are dynamically extracted from the real production environment.

4. The system of claim 1, wherein processing the additional test cases using the AI model comprises:
identifying anomalies arising from associations of a second set of CFS features and a second set of NFS features; and
providing a prediction of whether the identified anomalies would cause failure of the software product when deployed in the real production environment.

5. The system of claim 1,
wherein the identified anomalies are of one or more types of anomalies,
wherein a set of pre-defined rules includes different confidence value thresholds for each type of anomaly of the one or more types of anomalies, and
wherein determining whether to deploy the software product comprises comparing the first confidence value and the second confidence value associated with respective types of anomalies to the set of pre-defined rules for deploying software products.

6. The system of claim 5,
wherein determining whether to deploy the software product is performed by a decision engine that receives the set of pre-defined rules from a rules engine.

7. The system of claim 1,
wherein the first set of CFS features is a subset of CFS features pre-defined by a billing system, and
wherein the first set of CFS features is associated with a type of the software product or a client associated with the software product.

8. The system of claim 1,
wherein the first set of NFS features is a subset of NFS features that a network provisioning engine (NPE) uses to provision multiple network engines to enable the software product for a customer, and
wherein the NFS features are defined by a network provisioning catalog in communication with the NPE using the CFS features pre-defined by a billing system.

9. The system of claim 1,
wherein the AI model is continuously trained using training data extracted from the real production environment, and
wherein the training data includes types of anomalies arising from associations of CFS features and NFS features and an outcome of whether the types of
anomalies resulted in a software product failure or not.

10. The system of claim 1, further caused to:
responsive to determining to deploy the software product in the real production environment, causing deployment of the software product in the real production environment.

11. A staging validation system for validating software products for production deployment, the system comprising:
at least one hardware processor; and
at least one non-transitory memory storing instructions, which, when executed by the at least one hardware processor, cause the system to:
receive staging test results associated with a software product from a staging testing unit,
wherein the staging test results are obtained by testing the software product with a test set that imitates a real production environment,
wherein the test set includes associations of a set of customer-facing service (CFS) features and a set of network-facing service (NFS) features, and
wherein the staging test results include identified anomalies arising from the associations of the set of CFS features and the set of NFS features;
process, using an AI model, the staging test results to produce a confidence value indicating whether the identified anomalies have a likelihood of causing a failure of the software product when deployed in the real production environment; and
determine, using the confidence value, whether to deploy the software product in the real production environment.

12. The system of claim 11, further caused to:
transmit an indication of the determination of whether the software product should be deployed in the real production environment to a continuous integration and continuous deployment (CICD) handler; and
responsive to a determination that the software product is to be deployed, cause the CICD handler to deploy the software product.

13. The system of claim 11,
wherein the identified anomalies are of one or more types of anomalies,
wherein a set of pre-defined rules includes different confidence value thresholds for each type of anomaly of the one or more types of anomalies, and
wherein determining whether to deploy the software product comprises comparing the confidence value associated with respective types of anomalies to the set of pre-defined rules for deploying software products.

14. The system of claim 13,
wherein determining whether to deploy the software product is performed by a decision engine that receives the set of pre-defined rules from a rules engine.

15. The system of claim 11,
wherein the set of CFS features is a subset of CFS features pre-defined by a billing system, and
wherein the set of CFS features is associated with a type of the software product or a client associated with the software product.

16. The system of claim 11, further caused to:
responsive to determining to deploy the software product in the real production environment, causing deployment of the software product in the real production environment.

17. A computer-implemented method for validating telecommunications network software products for production deployment, the method comprising:
receiving staging test results associated with a software product,
wherein the staging test results include associations of a first set of customer-facing service (CFS) features and a first set of network-facing service (NFS) features, and
wherein the staging test results include identified anomalies arising from the associations of the first set of CFS features and the first set of NFS features;
processing, using an AI model, the staging test results to produce a first confidence value indicating whether the identified anomalies have a likelihood of causing a failure of the software product when deployed in a real production environment;
receiving additional test cases extracted from one or more deployed software products,
wherein the additional test cases are selected to include at least one association between CFS features and NFS features different from the associations in the test set;
processing, using the AI model, the additional test cases to produce a second confidence value predicting whether the additional test cases would cause a failure of the software product when deployed in the real production environment; and
determining, using the first confidence value and the second confidence value, whether to deploy the software product in the real production environment.

18. The method of claim 17, further comprising:
transmitting an indication of the determination of whether the software product should be deployed in the real production environment to a continuous integration and continuous deployment (CICD) handler; and
responsive to a determination that the software product is to be deployed, causing the CICD handler to deploy the software product.

19. The method of claim 17,
wherein the additional test cases are dynamically extracted from the real production environment.

20. The method of claim 17, further caused to:
responsive to determining to deploy the software product in the real production environment, causing deployment of the software product in the real production environment.
